(19) United States
(12) Patent Application Publication
(10) Pub. No.: US 2015/0147373 A1
(43) Pub. Date: May 28, 2015

(54) ANTIFUNGAL PROTECTIVE FILM

(71) Applicants: Michael KOHLA, Havixbeck (DE); Dana SIEWERT, Bocholt (DE); Matthias PERICK, Ahaus-Altstaette (DE)

(72) Inventors: Michael KOHLA, Havixbeck (DE); Dana SIEWERT, Bocholt (DE); Matthias PERICK, Ahaus-Altstaette (DE)

(21) Appl. No.: 14/525,325

(22) Filed: Oct. 28, 2014

(30) Foreign Application Priority Data
Oct. 29, 2013 (EP) 13190667.9

(51) Int. Cl. A01N 25/34; A01N 59/02; C08J 9/00; A01N 37/02

(52) U.S. Cl. CPC A01N 25/34; A01N 37/02; A01N 59/02; C08J 9/0033
USPC 424/405; 424/711; 424/78.31; 264/54

(57) ABSTRACT

In an antifungal protective film having at least one layer and an acidifying polymer and a disulfite the at least one film layer includes fluid-filled bubbles or cells that are created by foaming. The cells created by foaming during the extrusion enable the generated sulfur dioxide to collect inside this film layer, thereby being buffered and achieving a long-term action releasing the antifungal sulfur dioxide. The film can have a single foamed layer containing the polymer and disulfite or such a layer sandwiched between two outer layers having different properties, all produced by coextrusion.

### FIELD OF THE INVENTION

The present invention relates to an antifungal protective film. More particularly this invention concerns such a film used in packaging and a method of making the film.

### BACKGROUND OF THE INVENTION

A known antifungal protective film made of an acidifying polymer and a disulfite is well known. Such a film is used, in particular, for packaging food. In order to be able to transport food and, in particular, fruit, over long distances without degradation, they are packaged for transport in an atmosphere having antifungal action. Standard antifungal plastic products are used in packaging, covers, pads, or the like.

Essentially, two different types of fungicidal action are possible, either by direct contact with the item to be protected, or by generating around the item an atmosphere containing a gaseous antifungal substance.

For packaging food, for example, U.S. Pat. No. 3,559,562 discloses pads used in the package that release sulfur dioxide (SO₂). This entails the disadvantage that the release of sulfur dioxide cannot be precisely controlled in this type of pad, and, in particular, is a function of the ambient temperature. Excessive release of sulfur dioxide can result in damage, in particular, in bleaching of the packaged product, while at the same time detrimental health-related effects to a user are also possible. In addition, the risk also exists that the effect of the pad will be exhausted after a relatively short protective life.

EP 1 117 599 [U.S. Pat. No. 6,776,998] discloses an antifungal protective film in the form of packaging that contains an acidifying polymer and a disulfite in order to achieve a uniform sulfur dioxide release rate over an extended period of time.

The packaging film is produced from a polymer mixture that includes ethylene vinyl acetate (EVA) as the acidifying polymer and another polymer, in particular, linear polyethylene with a substantially different water transmission rate.

An acidifying polymer is understood here within the meaning of the invention to refer to a plastic that releases H⁺ ions in a moist environment or as induced by the surrounding humidity, thereby creating an acidic environment.

Disulfites, in particular, potassium disulfite and sodium disulfite, decompose in an acidic environment so as to generate sulfur dioxide that has a fungicidal action. Analogously, sodium disulfite and potassium disulfite are also employed as food additives identified as E223 and E224, although the substances do act as an irritant or have a detrimental health effect at high concentration. EP 1 117 599 provides the advantage of achieving a relatively slow, long-term process of releasing sulfur dioxide as the result of a two-step process - specifically, having the acidifying polymer generate an acidic environment while also decomposing the disulfite in an acidic environment. In particular, the rate of generating sulfur dioxide as set forth in EP 1 117 599 can also be modified by mixing the acidifying polymer ethylene vinyl acetate with another polymer that differs in terms of its water transmission rate. Adjusting the water transmission rate as part of the described process allows the creation of an acidic environment to be modified by the EVA.

### OBJECTS OF THE INVENTION

It is therefore an object of the present invention to provide an improved antifungal packaging film.

Another object is the provision of such an improved antifungal packaging film that overcomes the above-given disadvantages, in particular that exhibits even further improved properties in terms of the long-term release of sulfur dioxide.

### SUMMARY OF THE INVENTION

In an antifungal protective film having at least one layer and an acidifying polymer and a disulfite the at least one film layer includes fluid-filled bubbles or cells that are created by foaming.

The cells created by foaming during the extrusion enable the generated sulfur dioxide to collect inside this film layer, thereby being buffered and achieving a long-term action releasing the antifungal sulfur dioxide. The release of the antifungal sulfur dioxide from the protective film is thus possible over an extended period of time, with the additional result that variations in the ambient conditions become less important.

Relative to an unfoamed film layer, foaming the at least one film layer yields an increase in volume corresponding to the total volume of the created cells. As the film layer is foamed to a stronger degree, the long-term action accordingly becomes greater due to the cells. On the other hand, the protective film should also exhibit sufficient strength and stability whereby in an especially preferable approach the cells are not open and interconnected analogously to a sponge such that the sulfur dioxide would be able to move essentially freely within the foamed film layer. The density of the closed-cell foamed layer is thus, for example, between 0.1 g/cm³ and 0.9 g/cm³, preferably between 0.2 g/cm³ and 0.8 g/cm³, and especially preferably between 0.4 g/cm³ and 0.6 g/cm³.

An especially uniform configuration of the cells is achieved if the foamed film layer has a fine-cell foam structure that is created, for example, by a so-called MuCell process.

A foaming agent can be added here to the molten plastic during extrusion, the foaming agent producing a foaming action during extrusion or immediately after emerging from the extrusion die. In particular, physical foaming is a possible approach whereby first a foaming agent is added under pressure to the melt, then expands when the protective film emerges from the die gap. Nitrogen (N₂) and carbon dioxide (CO₂), are especially appropriate as foaming agents. The foaming agent can be either as a gas or a supercritical fluid that combines the non-compressibility of a liquid and the solubility properties of a gas. Water, either liquid water or water vapor, can furthermore be the foaming agent, this approach having the advantage that in terms of generating an acid environment by decomposing the acidifying polymer a sufficient quantity of water or moisture is already present after the protective film is produced.

In the extruder the foaming agent enters into solution with the molten polymer where it creates a distributed monophase system with the molten plastic. Upon emerging from the extrusion die, a rapid pressure drop enables nucleation sites to be created in the molten polymer. The gas or water vapor is released from the molten material in a controlled fashion, thereby creating a very fine, uniform foam structure. One of several analogous processes is described in U.S. Pat. No. 6,051,174.

In order to enable the foaming to create the smallest cells in the most uniform way possible, the foamed layer can include the admixture of particles that facilitate the creation of cells during the extrusion process and that are thus called nucleating agents. This admixture of particles can be composed, for example, of talcum, or include talcum as its principal component.

The invention provides a variety of possible approaches for further implementing an embodiment of the antifungal protective film. For example, the protective film can in principle also be produced as a monofilm that is composed only of the foamed protective layer.

In a preferred embodiment of the invention, however, the protective film has a multilayer co-extruded structure, preferably comprising three or four layers.

A multilayer structure in principle enables the acidifying polymer and the disulfite to be contained in different film layers. Preferably, however, the acidifying polymer and the disulfite are both contained together in the same film layer. The acidifying polymer, in particular EVA, in this film layer can be the single polymer component, or can be present in mixtures together with another polymer, such as, for example, polyethylene. Additional mixing with yet another polymer, in particular, a polyolefin, enables overall production costs to be reduced, while this mixing also allows the permeability to water to be adjusted.

If the acidifying polymer in the relevant layer is mixed together with another polymer, the relative proportion of the acidifying polymer preferably amounts to, by weight, between 5% and 50%, with the proportion for disulfite being by weight between 10% and 30%. The relative proportions must be selected taking into account the desired release rate and the desired release period. Depending on the how the protective film is to be used, it may also be necessary to consider avoiding an excessively high concentration of sulfur dioxide specifically in closed spaces, cases, or containers.

The acidifying polymer components must readily dissociate sufficiently under the effect of moisture so as to provide an accelerated decomposition of disulfite producing sulfur dioxide under the conditions present in the protective film. Based on the above considerations, an acidifying polymer is preferably used that has an acidity constant of less than 5. The acidity constant, also known as the pKₐ value, is an equilibrium constant that is a measure of the strength of an acid.

In addition to ethylene vinyl acetate (EVA), which is especially preferred within the scope of the invention, other possible acidifying polymers include ethylene methyl acrylate (EMA), ethylene butyl acrylate (EBA), and ethylene acrylic acid (EAA).

Disulfite can in principle be converted at a low level to form sulfur dioxide directly with water, although as set forth in the invention appropriate generation rates are achieved only when the acidifying polymer is used.

In the case of a multilayer, at least three-layer structure, the film layer containing the acidifying polymer and the disulfite is preferably the core layer between two outer layers. This then provides a functional separation whereby the core layer is responsible for producing the antifungal sulfur dioxide being protected by the outer layers. The outer layers here also create a diffusion barrier whose permeability is adjusted for the desired release period. In addition, direct contact of the disulfite contained in the core layer with a packaged item can also precluded by the outer layers.

The outer layers can also be employed to provide desired mechanical properties to the protective film in its entirety, or also to provide additional functional properties such as effective weldability or the like.

It is also possible within the scope of the invention for at least one of the two outer layers or the core layer to be foamed. Foaming the outer layers enables the sulfur dioxide, once it is generated, to be taken up by or stored in the core layer as it moves through the outer layers into the cells.

What is preferred, however, is an embodiment in which the core layer is foamed since this also produces an enlarged volume in terms of generating sulfur dioxide. In addition, the unfoamed outer layers are then flat, thereby providing a protective film with especially effective functional properties.

The thickness of the core layer in the described three-layer structure can measure, for example, between 30 μm and 300 μm, and in particular, between 50 μm and 150 μm, while the two outer layers are typically thinner, with a thickness, for example, between 10 μm and 40 μm. The outer layers are preferably composed of a polyolefin, in particular, polyethylene in order to achieve advantageous production costs. For example, a mixture of low-density polyethylene (PE-LD) and linear low-density polyethylene (PE-LLD) is especially appropriate. The referenced materials can also be provided as an added component in the core layer. The total thickness of the protective film can measure between 50 μm and 400 μm, in particular, between 70 μm and 230 μm. The protective film is typically flexible and provided with a cloudy aspect at least due to the foaming. The protective film can in principle also be dyed so as to be opaque or non-translucent through the addition of pigment.

The disulfite employed is preferably potassium disulfite that releases sulfur dioxide in an acidic environment.

The invention also relates to a method of producing the described protective film by coextrusion, in that a disulfite and an acidifying polymer are added to a synthetic-resin molding compound for one of the film layers, a foaming agent being added in an extruder to the compound containing the disulfite and the acidifying polymer, such that the emerging molten protective film has a foamed layer created by the foaming agent.

As was described above, water vapor can be provided as the foaming agent. This approach then yields the advantage that a certain quantity of water is already present in the protective film and, in particular, the cells created by the foaming. Such water aids in the formation of SO₂ from disulfite.

The invention also relates to the use of the protective film for packaging textile and leather goods.

The inventive embodiment of the protective film having an extended long-term and repository action also enables clothing and shoes, including other leather goods, to be protected against the formation of mildew/mold over an extended time period, in particular, during maritime transport.

A wide variety of different goods can be protected in this way, such as shoes or other leather goods, as well as textiles. First, the film according to the invention in the form of a simple wrapping film can be placed around the product to be protected. A well-known approach, for example, is to wrap shoes in paper that, for example, can be replaced by the protective film according to the invention.

The protective film is typically heat-sealable since the protective film is composed of thermoplastic polymer. This is true especially in the case of a multilayer structure where the outer layers are unfoamed and are composed of polyolefin. A kind of bag can thus be created by heat-sealing that accommodates the product to be protected. For example, a textile item can also be visible in a bag composed of the protective film so that this bag is in fact optionally suited for use as sales packaging.

A piece of the protective film can furthermore also be inserted into the items to be protected. Shoe, handbags, or the like, for example, can be padded with the protective film. With items of clothing, the protective film can be inserted into pockets or other locations as filler padding.

Last, it may also be sufficient for the protective film to be simply adjacent the item to be protected. For example, the protective film can also be inserted separately as a folded or wadded piece into a shoe box or other secondary packaging.

### BRIEF DESCRIPTION OF THE DRAWING

The above and other objects, features, and advantages will become more readily apparent from the following description, reference being made to the accompanying drawing in which:

FIGS. 1, 2, and 3 are sections through three films according to the invention;

FIG. 4 shows shoes wrapped in a protective film according to the invention;

FIG. 5 shows shoes in a box together with a piece of the protective film; and

FIG. 6 is a schematic diagram illustrating an apparatus for carrying out the method of this invention.

### SPECIFIC DESCRIPTION OF THE INVENTION

As seen in FIG. 1, a multilayer protective film SF according to the invention is produced by coextrusion, that is extruded in multiple layers from a single multiorifice slot nozzle. A core layer 1 is disposed between two outer layers 2 in a symmetrical structure. The core layer 1 contains an acidifying polymer, in particular, ethylene vinyl acetate (EVA) and a disulfite, in particular, potassium disulfite or sodium disulfite. The core layer 1 is furthermore foamed, thereby creating gas cells 3 inside the core layer 1.

The combination of the acidifying polymer and the disulfite enable sulfur dioxide to be generated over an extended time period as an antifungal gas in an acidic environment, to which end a sufficient quantity of water or moisture must be present to generate H⁺ ions, it being possible, for example, for water to diffuse into the core layer 1 from the surrounding environment.

The cells 3 are created in an extrusion process as shown in FIG. 6 in which foaming and nucleating agents are added from a supply 13 to the compound for the core layer 1 along with the acidifying polymer from a supply 12 and a disulfite from a supply 14. As the extruded film SF emerges from an extrusion die 11, the foaming agent from the supply 13 generates foam and thereby creates the cells 3. The addition of a nucleating agent, for example talcum, also creates an especially uniform, small-celled structure for the core layer 1.

In a specific embodiment, the protective film shown in FIG. 1 includes outer layers 2 having a thickness of 25 μm, each of these being composed one half PE-LLD and one half PE-LD.

The core layer 1 of a thickness of 90 μm in the foamed state contains by weight:

20% potassium disulfite,

37% PE-LLD,

13% talcum as the nucleating agent for the foaming process,

10% PE-LD, and

20% EVA as the acidifying polymer.

Eliminating the increase in volume from foaming, that is, with a layer of the same material without cells would produce a thickness of 50 μm with the same input material.

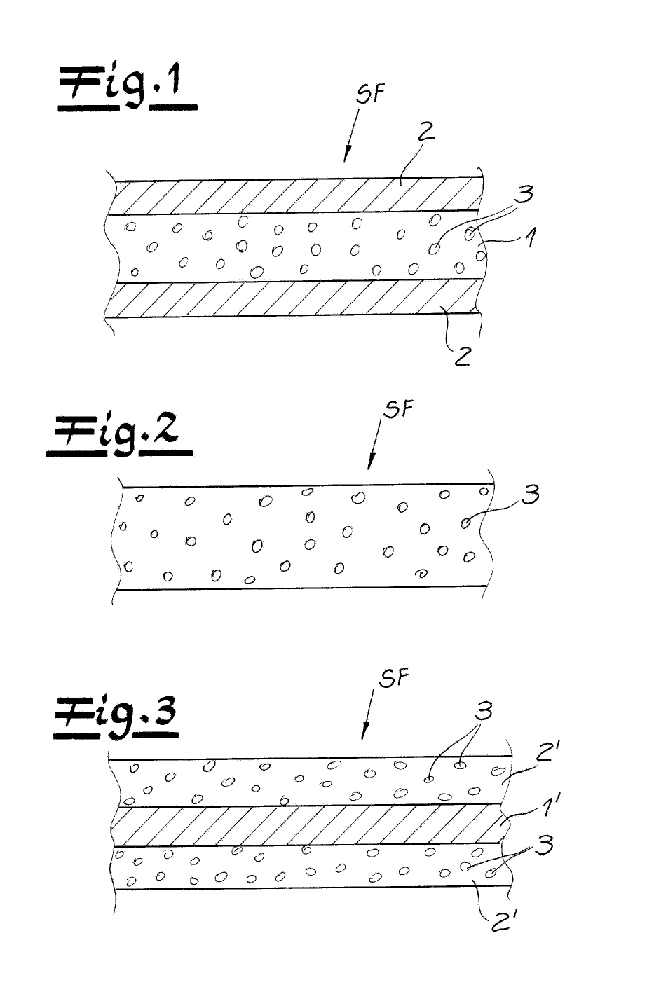

FIG. 2 shows an alternative embodiment in which the protective film SF is a monofilm. The monofilm, as described above, contains an acidifying polymer and a disulfite, it being possible in principle for the acidifying polymer to be the single polymer component of the monofilm or the core layer 1 of FIG. 1.

Finally, FIG. 3 shows another variant in which the disulfite and the acidifying polymer are also present in the core layer 1′ but the two outer layers 2′ include the cells 3 that are created by foaming. Sulfur dioxide (SO₂) is then produced in the core layer 1′ but can be taken up by diffusion from both sides into the cells of the outer layers 2′ and temporarily stored there.

In another aspect of this invention, the protective film SF according to the invention is used for packaging textile and leather goods.

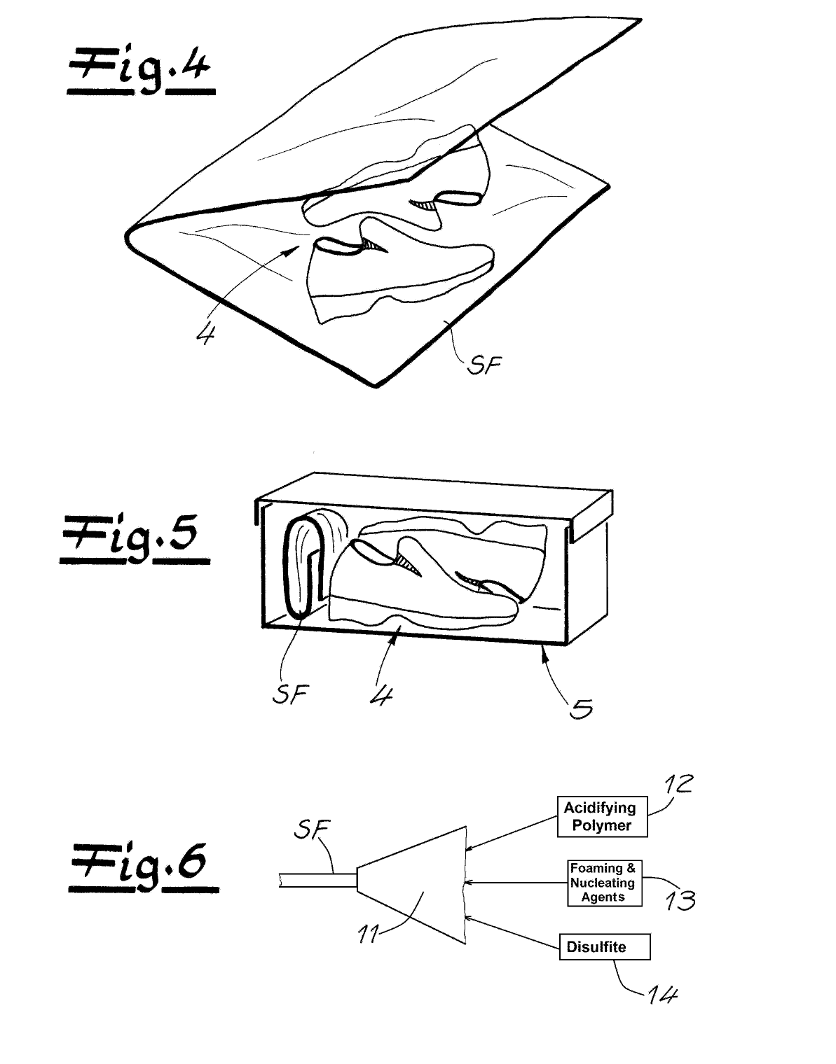

The antifungal protective film in FIG. 4 can be provided, for example, as a type of wrapping film to accommodate a product to be protected, shoes 4 in the embodiment. This yields the advantage that the protective film SF also provides a certain level of mechanical protection, while a multilayer structure as in FIG. 4 enables direct contact to be avoided between the product to be protected and the disulfite. In addition, the fact that only a uniform, relatively low concentration of sulfur dioxide is released also enables degradation of the surface, hazards to a user, or the like to be reliably precluded.

FIG. 5 shows an alternative embodiment for packaging textile and leather goods with the protective film SF, where a wadded or folded-up piece of the protective film SF is held in a secondary package, for example, a box 5, together with the item to be protected, that is, for example, the shoes 4.

We claim:

1. In an antifungal protective film having at least one layer and an acidifying polymer and a disulfite, the improvement that the at least one film layer includes cells that are created by foaming.

2. The antifungal protective film defined in claim 1, wherein the foamed film layer has a density of between 0.1 g/cm³ and 0.9 g/cm³.

3. The antifungal protective film defined in claim 1, wherein the acidifying polymer has an acidity constant pKₐ of less than 5.

4. The antifungal protective film defined in claim 1, wherein the acidifying polymer is ethylene vinyl acetate, ethylene methyl acrylate, ethylene butyl acrylate, or ethylene acrylic acid.

5. The antifungal protective film defined in claim 1, wherein the film has a plurality of coextruded layers.

6. The antifungal protective film defined in claim 5, wherein the acidifying polymer and the disulfite are contained in different layers.

7. The antifungal protective film defined in claim 1, wherein the acidifying polymer and the disulfite are contained together in the one film layer.

8. The antifungal protective film defined in claim 7, wherein within the one film layer the relative proportion of the acidifying polymer by weight is between 5% and 50%, while the relative proportion of the disulfite by weight is between 10% and 30%.

9. The antifungal protective film defined in claim 7, wherein the film layer containing the acidifying polymer and the disulfite is foamed and has the cells.

10. The antifungal protective film defined in claim 1, wherein further comprising two outer layers sandwiching the one layer, the one film layer being between the outer layers and containing the acidifying polymer and the disulfite.

11. The antifungal protective film defined in claim 10, wherein the one layer between the outer layers has a thickness between 30 μm and 300 μm.

12. The antifungal protective film defined in claim 10, wherein the one layer between the outer layers includes a polymer mixture composed of the acidifying polymer and a polyolefin.

13. The antifungal protective film defined in claim 10, wherein the outer layers are composed of polyolefin.

14. The antifungal protective film defined in claim 1, wherein the disulfite is potassium disulfite.

15. The antifungal protective film defined in claim 1, further comprising:
respective bodies of water filling the cells, whereby sulfur dioxide generated by a reaction of the polymer and disulfite is absorbed and stored in the bodies of water.

16. Use of the film of claim 1 for packaging textile and leather goods.

17. A method of making an antifungal protective film, the method comprising the step of:
extruding from a nozzle a compound to form a film having at least one layer and containing a disulfite and an acidifying polymer; and
adding to the compound before extrusion a foaming agent such that on leaving the die the compound foams and forms a multiplicity of cells.
